(19) United States
(12) Patent Application Publication
(10) Pub. No.: US 2020/0251120 A1
(43) Pub. Date: Aug. 6, 2020

(54) METHOD AND SYSTEM FOR INDIVIDUALIZED SIGNAL PROCESSING OF AN AUDIO SIGNAL OF A HEARING DEVICE

(71) Applicant: SIVANTOS PTE. LTD., SINGAPORE (SG)

(72) Inventor: MATTHIAS FROEHLICH, ERLANGEN (DE)

(21) Appl. No.: 16/782,111

(22) Filed: Feb. 5, 2020

(30) Foreign Application Priority Data
Feb. 5, 2019 (DE) 102019201456

(51) Int. Cl. G10L 21/02; G10L 17/00; G10L 17/04; G06K 9/00; G10L 25/90; G10L 17/02; G10L 25/84; G10L 25/60; G10L 17/18; G10L 21/0272; H04M 1/725

(52) U.S. Cl. CPC G10L 21/0205; G10L 17/005; G10L 17/04; G06K 9/00228; G10L 25/90; H04M 1/725; G10L 25/84; G10L 25/60; G10L 17/18; G06K 9/00362; G10L 21/0272; G10L 17/02

(57) ABSTRACT

A method for individualized signal processing of an audio signal of a hearing device. In a recognition phase, an auxiliary device generates a first image capture. A conclusion is reached based on the first image capture regarding the presence of a preferred conversation partner, and thereupon a first audio sequence of the audio signal and/or of an auxiliary audio signal of the auxiliary device is analyzed for characteristic speaker identification parameters. The speaker identification parameters ascertained from the first audio sequence are stored in a database. In an application phase, the audio signal is analyzed with respect to the stored speaker identification parameters, and is thereby evaluated with respect to a presence of the preferred conversation partner. When the preferred conversation partner is detected as being present, the partner's signal contributions in the audio signal are amplified.

### CROSS-REFERENCE TO RELATED APPLICATION

This application claims the priority, under 35 U.S.C. § 119, of German patent application DE 10 2019 201 456, filed Feb. 5, 2019; the prior application is herewith incorporated by reference in its entirety.

### BACKGROUND OF THE INVENTION

### Field of the Invention

The invention relates to a method for individualized signal processing of an audio signal of a hearing device. The invention also relates to a system with a hearing device for carrying out such a method.

In the field of the audio signal processing of speech signals, namely audio signals the signal components of which originate to a substantial extent from speech contributions, the problem often arises of needing to emphasize a speech contribution in a recorded audio signal against a noise background, i.e. to amplify the speech contribution relative to the other components of the signal. For audio signals that are to be played back with a significant time delay from when they were recorded, for example in the case of the audio track recordings for film productions, such amplification may be achieved by complex, non-real-time-capable signal processing algorithms; but depending on the type of noise background and the quality requirements of the output signal to be generated, this is much more difficult when real-time signal processing is necessary.

Such signal processing is present, for example, when a hearing device is used to compensate for a hearing impairment of the hearing device user. Because for persons with hearing impairment such amplification in speech situations may be particularly unpleasant due to the resulting loss of speech intelligibility, especially in conversational situations, it is particularly important for a hearing device to amplify speech signals compared to a noise background or generally to improve the speech intelligibility of an audio signal with corresponding speech signal contributions.

Because a hearing device should provide the user with the real acoustic environment in which the user is present, in a way that is tailored as closely as possible to the user's hearing impairment, the signal processing is also carried out in real time or with as little delay as possible. The amplification of speech contributions becomes an important form of support for the user, particularly in more complex acoustic situations in which a plurality of speakers are present, not all of whom may be considered relevant (for example a cocktail party situation).

However, due to the user's everyday life and life situation, there are usually some persons whose speech contributions should always be amplified due to their assumed importance for the user, irrespective of other aspects of the situation or other conditions. This is usually the case for close family members of the user, or for caregivers, particularly in the case of older users. Controlling such an “individualized” amplification of the speech contributions of the user's preferred conversation partners would mean that, especially in more complex acoustic environments and situations, the user would have to frequently control and change the respective mode of signal processing. This, however, is undesirable, not least because of the negative effects on the user's ability to concentrate on speech contributions.

### SUMMARY OF THE INVENTION

It is accordingly an object of the invention to provide a method for audio signals of a hearing device, which overcomes the above-mentioned and other disadvantages of the heretofore-known devices and methods of this general type and which renders it possible to emphasize the speech contributions of preferred conversation partners in real time, as automatically and reliably as possible, compared to other signal contributions. It is a further object of this invention to provide a system with a hearing device that is suitable and equipped to perform such a method.

With the above and other objects in view there is provided, in accordance with the invention, a method for individualized signal processing of an audio signal of a hearing device, the method comprising:

in a recognition phase:

generating a first image capture with an auxiliary device;

inferring a presence of a preferred conversation partner from the first image capture, and based thereon, analyzing a first audio sequence of the audio signal and/or an auxiliary audio signal of the auxiliary device for characteristic speaker identification parameters; and

storing the speaker identification parameters ascertained in the first audio sequence in a database; and

in an application phase:

analyzing the audio signal with respect to the stored speaker identification parameters, and thus evaluating the audio signal with respect to a presence of the preferred conversation partner; and

if the presence of the preferred conversation partner is detected, emphasizing the preferred conversation partner's signal contributions in the audio signal.

In other words, the first above-mentioned object is accomplished according to the invention by a method for individualized signal processing of an audio signal of a hearing device, in which an auxiliary device generates a first image capture for an audio signal in a recognition phase, a presence of a preferred conversation partner is inferred from the image capture, and then a first audio sequence of the audio signal and/or an auxiliary audio signal of the auxiliary device is analyzed for characteristic speaker identification parameters, and the speaker identification parameters ascertained in the first audio sequence are stored in a database. It is also envisioned according to the invention that in an application phase, the audio signal is analyzed with respect to the stored speaker identification parameters and as a result is evaluated with respect to the preferred conversation partner's presence, and the preferred conversation partner's presence is recognized, that partner's signal contributions in the audio signal are particularly emphasized relative to other signal contributions. Configurations that are advantageous and in part inventive in their own right are described in the dependent claims and in the following description.

With the second above-mentioned and other objects in view there is also provided, in accordance with the invention, system with a hearing device and an auxiliary device. The auxiliary device is configured to generate an image capture, and the system is configured to carry out the above-described method. Preferably, the auxiliary device is designed as a mobile telephone. The system according to the invention thus shares the advantages of the method according to the invention. The advantages resulting for the method and for its below-described refinements may be transferred analogously to the system.

An audio signal of a hearing device, here, comprises in particular a signal of this kind, the signal contributions of which are output to the hearing of a hearing device user as output sound, either directly, or in one refinement, via an output transducer of the hearing device. In particular, the audio signal is thus provided by an intermediate signal of the signal processing processes that take place in the hearing device; thus, it is used not only as a secondary control signal for the processing of another primary signal for output from the output transducer(s) of the hearing device, but is itself such a primary signal.

The recognition phase, here, is provided in particular by a time period in which the speaker identification parameters are ascertained; the presence of the preferred conversation partner will be recognized based on these parameters in the application phase. In this context, the application phase itself is provided in particular by a time period during which the signal processing is adapted according to the presence of the preferred conversation partner, which has been recognized as described.

Here and below, an “image capture” encompasses in particular a still image and a video sequence, i.e. a continuous sequence of a plurality of still images. The auxiliary device is adapted accordingly, in particular for the generation of the first image capture, i.e. in particular by a camera or a similar device for optically capturing images of an environment. Preferably, the auxiliary device is adapted to send a corresponding command to the hearing device in order to start the analysis process, in addition to or triggered by the image capture.

The presence of the preferred conversation partner is inferred from the first image capture, preferably immediately following its generation. Preferably, therefore, between the creation of the first image capture, which in particular automatically initiates a corresponding analysis of the generated image material with regard to the preferred conversation partner, and the beginning of the first audio sequence of the audio signal, only the time required for this analysis elapses, namely preferably less than 60 seconds, and particularly preferably less than 10 seconds.

However, in the recognition phase, to analyze the first audio sequence of the audio signal, it is not necessary to record the first audio sequence after the first image capture. Rather, during the recognition phase, a continuous (in particular only intermediate) recording of the audio signal may also take place, and following the first image capture, the first audio sequence may be taken from the recording of the audio signal by means of the time reference of the first image capture; this time reference need not necessarily mark the start of the first audio sequences, but may instead, for example, mark the middle or end.

In particular, the first audio sequence has a predetermined length, preferably at least 10 seconds, and particularly preferably at least 25 seconds.

The determination of whether a person is a preferred conversation partner is based in particular on criteria that the hearing device user predefines, for example by comparing the first image capture with image captures of persons who the hearing device user indicates are particularly important, such as family members or close friends. Such an indication may, for example, consist in classifying images of a named person in a virtual photo archive as a “favorite.” However, the selection may also be made automatically without the user having to explicitly specify a preferred conversation partner, for example by performing a frequency analysis within the image data stored in the auxiliary device and identifying particularly frequently recurring persons as preferred conversation partners.

Characteristic speaker identification parameters, here, refer in particular to those parameters that enable identifying the speaker based on speech, and for this purpose quantifiably describe features of a speech signal, for example spectral and/or temporal, i.e. in particular prosodic features. Based on the speaker identification parameters ascertained in the recognition phase and stored in the database, in the application phase the audio signal is analyzed with regard to these stored speaker identification parameters, in particular in response to a corresponding command or as a default setting in a specially set hearing device program, in order to be able to recognize the presence of a person who has been defined in advance as a preferred conversation partner.

Thus, while during the recognition phase the presence of a preferred conversation partner is recognized based on the first image capture, and the analysis of the first audio sequence is thus initiated to obtain the characteristic speaker identification parameters, the preferred conversation partner's presence may be detected in the application phase based on these speaker identification parameters stored in the database. The signal processing of the hearing device is then adjusted to increase the preferred conversation partner's signal contributions or presumed signal contributions in the audio signal relative to other signal contributions, and particularly with respect to other speech contributions and a noise background, i.e. to amplify the contributions of the preferred conversation partner relative to these. The database is preferably implemented in a corresponding, in particular non-volatile, memory of the hearing device.

The evaluation of the audio signal in the application phase with regard to the presence of the preferred conversation partner may be carried out in particular by comparing corresponding feature vectors, for example by calculating a distance or by calculating a coefficient weighted distance. In such a feature vector, the individual entries are each given by a numerical value of a specific speaker identification parameter, so that it is possible to make a coefficient-wise comparison with a feature vector stored for a preferred conversation partner and, if necessary, to make a check with regard to individual thresholds for the respective coefficients.

Favorably, the preferred conversation partner may be identified in the first image capture by means of facial recognition. Facial recognition, here, refers in particular to an algorithm that is adapted and intended to use pattern recognition methods to recognize an object in an image capture with an a priori unknown image content as a human face and also to assign it to a specific individual from a number of predefined persons.

For an auxiliary device, a mobile telephone and/or smartglasses may expediently be used. In particular, in this case, the hearing device user operates the mobile telephone or wears the smartglasses on the head. Smartglasses are glasses that have a data processing unit, in order for example to prepare information such as web pages etc. and then display such information visually to the wearer, in the wearer's field of vision. Such smartglasses are preferably equipped with a camera to generate image captures of the wearer's field of vision, the image captures being captured by the data processing unit.

In an alternative configuration, the hearing device is integrated into the smartglasses, i.e. the input and output transducers of the hearing device as well as the signal processing unit are at least partially connected to or inserted into a housing of the smartglasses, for example at one or both temples.

Preferably, at least part of the analysis in the recognition phase and/or the generation of the audio signal for the recognition phase takes place in the auxiliary device. In particular, if the auxiliary device is provided by a mobile telephone, its high computing power compared to conventional hearing devices may be used analysis in the recognition phase. The audio signal may be transmitted from the hearing device to the mobile telephone for analysis, because in the application phase, the audio signal generated in the hearing device itself should usually be examined for speaker identification parameters. Thus, there are no inconsistencies due to different audio signal generation sites in the two phases. On the other hand, the mobile telephone may also generate the audio signal itself during the recognition phase by means of an integrated microphone. Preferably, such a generation of the audio signal outside the hearing device should be accounted for when analyzing the recognition phase and/or analyzing the application phase, for example by means of transfer functions.

In accordance with an advantageous embodiment, the following parameters may be analyzed as speaker identification parameters: a number of pitches and/or a number of formant frequencies and/or a number of phonospectra and/or a distribution of stresses and/or a distribution of phones and/or pauses in speech over time. In particular, different pitch characteristics in tonal languages such as Chinese or in tonal accents such as in Scandinavian languages and dialects may be analyzed within the framework of a pitch analysis. An analysis of formant frequencies is particularly advantageous against the background that formant frequencies determine the vowel sound, which is particularly characteristic for the sound of a voice, and may thus also be used for potential identification of a speaker. In particular, the analysis comprises an analysis of the temporal progression of transitions respectively between individual pitches, phonemes, speech-dynamic stresses and/or formats or formant frequencies. The speaker identification parameters to be stored may then be determined preferably based on the temporal progressions and in particular based on the transitions mentioned above.

Here, a phone is in particular the smallest isolated sound event or smallest acoustically resolvable speech unit, for example an explosive or hissing sound that corresponds to a consonant. Based on the spectral distribution of the phone, characteristic peculiarities, for example lisping or the like, may be used to potentially identify a speaker as a preferred conversation partner. The analysis of the distribution of stresses, and particularly of linguistic stress, may include a temporal distance and amplitude differences of the stresses relative to each other and to the respective unstressed passages. The analysis of the temporal distribution of phones and/or pauses in speech over time, i.e. in some cases the speaking rate, may extend in particular to ascertaining characteristic irregularities.

It is also advantageous if the first audio sequence is decomposed into a plurality of sub-sequences, preferably partially overlapping, wherein for each of the sub-sequences a speech intelligibility parameter, for example a speech intelligibility index (SII) and/or a signal-to-noise ratio (SNR) is respectively ascertained and compared with an associated criterion, i.e. in particular with a threshold SII or SNR value or the like, and wherein for the analysis with respect to the characteristic speaker identification parameters, only those sub-sequences are used that respectively fulfill the criterion, i.e. are in particular above the threshold value. SII is a parameter that is intended to provide as objective as possible a measure for the intelligibility of speech information contained in a signal based on spectral information. There are similar definitions for quantitative speech intelligibility parameters, which may likewise be used here. The length of the sub-sequences may be selected in particular as a function of the speaker identification parameters under examination; a plurality of “parallel” decompositions of the first audio sequence are also possible. For investigating individual pitches, formant frequencies or phones, shorter sub-sequences may be selected, for example in the range of 100 milliseconds to 300 milliseconds; for temporal progressions, in contrast, sub-sequences with a length of 2 to 5 seconds are preferred.

Favorably, the first audio sequence is decomposed into a plurality of preferably partially overlapping sub-sequences, wherein the hearing device user's own speech activity is monitored, and for the analysis with regard to the characteristic speaker identification parameters, only those sub-sequences are used that have a proportion of the user's own speech activity that does not exceed a predetermined upper limit, and preferably have none of the user's own speech activity at all. The monitoring of speech activity may be accomplished, for example, via an “Own Voice Detection” (OVD) of the hearing device. The use of only those sub-sequences that have no or practically no own speech activity of the hearing device user ensures that the speaker identification parameters ascertained in these sub-sequences may be assigned to the preferred conversation partner with the highest possible probability.

Preferably, a second image capture is generated in the auxiliary device, wherein in response to the second image capture, a second audio sequence of the audio signal and/or of an audio signal of the auxiliary device is analyzed with regard to characteristic speaker identification parameters, wherein the speaker identification parameters stored in the database are adapted by means of the speaker identification parameters ascertained from the second audio sequence. Preferably in this case, the second image capture is identical in kind to the first, thus for example a new still image capture or a new capture of a video sequence. Preferably, the second image capture serves as the trigger for the analysis of the second audio sequence. In particular, during the recognition phase, and in particular until this phase may be deemed complete, an audio sequence is analyzed for characteristic speaker identification parameters using each image capture of the same kind as the first image capture, and the respective speaker identification parameters stored in the database are adapted accordingly.

The recognition phase may then be terminated after a predetermined number of analyzed audio sequences, or if the speaker identification parameters stored in the database are of sufficiently high quality. This is particularly the case if a deviation of the speaker identification parameters ascertained from the second audio sequence, relative to the speaker identification parameters stored in the database, falls below a limit value; repeatedly falling below the threshold value a predetermined number of times may also be required.

In this respect, it has proven advantageous if the adaptation of the speaker identification parameters stored in the database using the speaker identification parameters ascertained from the second audio sequence, or each subsequent audio sequence in the recognition phase, is carried out by means of an averaging, particularly arithmetic, weighted or recursive averaging, preferably also with at least some of the already stored speaker identification parameters, and/or using an artificial neural network. The stored speaker identification parameters may, for example, form the output layer of the artificial neural network, and the weight of the connections between the individual layers of the artificial neural network may be adjusted in such a way that speaker identification parameters of the second audio sequence, which are fed to the input layer of the artificial neural network, are mapped to the output view with as little error as possible, in order to generate a set of stored reference parameters that is as stable as possible.

Preferably, in the application phase, the analysis of the audio signal is initiated with respect to an additional image capture by the auxiliary device. This may comprise, in particular, that each time the auxiliary device generates an image capture, an analysis of the audio signal takes place in the hearing device with respect to the speaker identification parameters stored in the database, to determine the presence of the preferred speaker. In particular, the additional image capture may be evaluated for this purpose, also with regard to the presence of the preferred conversation partner, so that if the preferred conversation partner is present, an analysis of the audio signal is carried out specifically with regard to the speaker identification parameters of the present preferred conversation partner that are stored in the database. Preferably, the auxiliary device is adapted to send a corresponding command to the hearing device in addition to or triggered by the image capture. Alternatively, such an analysis may also be initiated by user input, so that, for example, at the beginning of a prolonged listening situation involving one of the user's preferred conversation partners, the user selects a corresponding mode or hearing device program in which the audio signal is repeatedly or continuously checked for the corresponding speech information parameters.

It is also advantageous if a number of persons present is determined in the first image capture, with the first audio sequence of the audio signal being analyzed based on the number of people present. If, for example, it is ascertained based on the first image capture that a multiplicity or even a plurality of people are present and in particular are also facing toward the hearing device user, speech components in the first audio sequence may not be from, or not consistently from, the preferred conversation partner, but from another person instead. This may affect the quality of the speaker identification parameters stored. In this case, the recognition phase may be temporarily suspended, and analysis of the first audio sequence may be omitted to save battery power if the analysis does not appear sufficiently promising or useful in view of the potential speakers present.

In one advantageous configuration of the invention, the first image capture is generated as part of a first image sequence, i.e. in particular a video sequence, wherein in the first image sequence a speech activity of the preferred conversation partner is recognized, in particular based on the mouth movements, and wherein the first audio sequence of the audio signal is analyzed as a function of the recognized speech activity of the preferred conversation partner. This makes it possible to take advantage of the particular advantages of video sequences captured by the auxiliary device for the method, with regard to specific personal information. If, for example, the first image sequence indicates that the preferred conversation partner is currently speaking, preferably the associated first audio sequence is analyzed for speaker identification parameters. If, on the other hand, it is clear from the first image sequence that the preferred conversation partner is not speaking, an analysis of the associated audio sequence may be dispensed with.

Favorably, the signal contributions of the preferred conversation partner are increased by means of directional signal processing and/or blind source separation (BSS). BSS is a method of isolating a certain signal from a mixture of a plurality of signals with limited information, and in this case, the mathematical problem is usually very under-determined. For the BSS, therefore, speaker identification parameters in particular may be used, i.e. these are used not only to recognize the presence of the preferred speaker, but also as additional information to reduce under-determination and thus better isolate the desired speech contributions in the potentially noisy audio signal from the background and amplify them accordingly.

The invention additionally relates to a mobile application for a mobile telephone with program code for generating at least one image capture, for automatically recognizing in the at least one image capture a person predefined as preferred, and for generating a start command for recording a first audio sequence of an audio signal and/or a start command for analyzing one or the first audio sequence for characteristic speaker identification parameters in order to recognize the person who has been predefined as preferred, if the mobile application is executed on a mobile telephone. The mobile application according to the invention shares the advantages of the method according to the invention. The advantages indicated for the method and for the refinements thereof may be transferred analogously to the mobile application. Preferably, here, the mobile application is executed on a mobile telephone, which is used in the above-described method as an auxiliary device of a hearing device. In particular, the or each start command is sent from the mobile telephone to the hearing device.

Other features which are considered as characteristic for the invention are set forth in the appended claims.

Although the invention is illustrated and described herein as embodied in method for individualized signal processing of an audio signal of a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic block diagram of a recognition phase of a method for individualized signal processing in a hearing device; and

FIG. 2 is a schematic block diagram of an application phase of the method for individualized signal processing in the hearing device according to FIG. 1.

Components and magnitudes that correspond to each other are respectively assigned the same reference signs in all drawings.

### DETAILED DESCRIPTION OF THE INVENTION

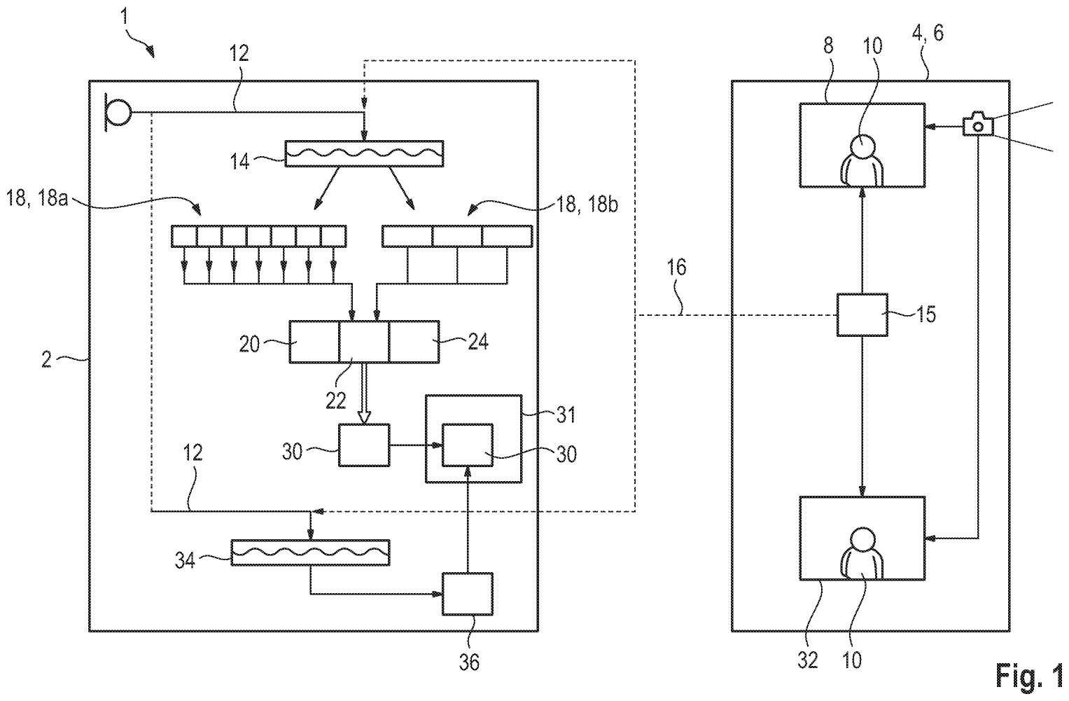

Referring now to the figures of the drawing in detail and first, particularly, to FIG. 1 thereof, there is shown a schematic block diagram of a recognition phase 1 of a method for individualized signal processing in a hearing device 2. The aim of the recognition phase 1 is to be able to ascertain, in a manner described below, certain acoustic parameters for certain persons in the immediate environment of a user of a hearing device 2, so that on that basis, signal components of an input signal of the hearing device 2 may be identified as speech contributions of the relevant persons, so that these speech contributions may be amplified in a targeted fashion for the user of a hearing device 2 against a noise background, but also against other speech contributions of other speakers. This is done in particular under the assumption that the speech contributions of these persons are of particular importance for the user of a hearing device 2 due to a personal relationship with the speakers.

The user of a hearing device 2 generates a first image capture 8 with an auxiliary device 4, designed in this case as a mobile telephone 6. For the auxiliary device 4, smartglasses (for example Google Glass) or a tablet PC, having been adapted for generating the first image capture 8, could be used alternatively or in addition to the mobile telephone 6 shown in FIG. 1. In the auxiliary device 4, the first image capture 8 is checked for the presence of a preferred conversation partner 10 by way of a corresponding facial recognition application. The persons stored as preferred conversation partners 10 are in particular those persons that the user of the hearing device 2 has marked as particularly important friends/favorites/close family members etc. in a photo application of the mobile telephone 6 and/or in a social network application installed on the mobile telephone 6.

If the facial recognition application now recognizes one of these persons, and thus a preferred conversation partner 10, as being present in the first image capture 8, a first audio sequence 14 is analyzed. The recognized presence of the preferred conversation partner 10 serves as a trigger for triggering the analysis of the first audio sequence 14 of the audio signal 12. As an alternative to the method described above, in which the first audio sequence is generated by the audio signal 12, which the input transducer (e.g. microphones) generates in the hearing device 2 itself, the first audio sequence 14 may also be generated by an auxiliary audio signal of the auxiliary device 4 (which is generated for example by an input or microphone signal of the mobile telephone 6), if the auxiliary device 4 is suitably designed for this purpose.

The specific technical implementation of the triggering mechanism of the analysis of the first audio sequence 14 by recognizing the preferred conversation partner 10 in the first image capture 8 may take place as follows: As a first alternative, a standard application for generating image captures in the auxiliary device 4 may be configured to automatically carry out the analysis with regard to the presence of the preferred conversation partner 10 immediately whenever a new image capture is generated, i.e. in particular when the first image capture 8 is generated, and a data comparison with the preferred persons stored in the standard application itself may be carried out for purposes of facial recognition. As a second alternative, an application 15 dedicated to carrying out the recognition phase may perform facial recognition and thus analysis of the presence or absence of the preferred conversation partner 10, on the auxiliary device 4 via immediate and direct access to the image captures generated in the auxiliary device 4.

In this case, there may additionally be a recognition of whether the preferred conversation partner 10 is present alone, in order to substantially exclude the possibility that other speakers might be present who could potentially interfere with the recognition phase 1. Moreover, the first image capture 8 may be captured as part of a first image sequence, not otherwise shown, wherein in the first image sequence, it is also recognized whether the preferred conversation partner 10 is currently undergoing a mouth movement corresponding to a speech activity, preferably via gesture and facial expression recognition of the dedicated application 15, so as to further reduce the potential influence of background noise.

If the presence of the preferred conversation partner 10 is detected in the first image capture 8, after successful detection of the preferred conversation partner 10 in the first image capture 8, the dedicated application 15 on the auxiliary device 4, which is furnished for the method, sends a trigger signal 16 to the hearing device 2. The first audio sequence 14 is then generated from the audio signal 12 (which was obtained by an input transducer of the hearing device 2) in the hearing device 2 for further analysis. In this case, the recognition of the preferred conversation partner 10 in the first image capture 8 may be performed by the standard application in the auxiliary device 4, so that the application 15 dedicated to the method only generates the trigger signal 16, or the application 15 dedicated to the method may perform the recognition in the first image capture 8 itself, and then also generate the trigger signal.

It is also possible (but not shown) that the first audio sequence 14 is generated from the auxiliary audio signal of the auxiliary device 4 for further analysis. Here, either the standard application for generating image captures in the auxiliary device 4 may output the trigger signal 15 to the application 15 dedicated to performing the method via a corresponding program interface—if recognition by the standard application has taken place—and the dedicated application 15 may then generate the first audio sequence 14 from the auxiliary audio signal of the auxiliary device 4 (for example by means of an input or microphone signal) and may subsequently further analyze it in a manner described below. Alternatively, by accessing the image captures generated in the auxiliary device 4, the dedicated application 15 may itself perform the recognition of the preferred conversation partner 10 in the first image capture 8 as described, and then generate the first audio sequence 14 from the auxiliary audio signal of the auxiliary device 4 for further analysis.

The first audio sequence 14 is then decomposed into a plurality of sub-sequences 18. In particular, the individual sub-sequences 18 may form different groups of sub-sequences 18a, 18b, with sub-sequences of the same group each having the same length, so that the groups of sub-sequences 18a, 18b result in a division of the first audio sequence 14 into individual blocks that are each 100 ms long (18a) or 2.5 seconds long (18b), and in each respective case reproduce the first audio sequence 14 in its entirety. In a first respect, the individual sub-sequences 18a, 18b are now subjected to an “own voice detection” (OVD) 20 with respect to the user of a hearing device 2, in order to filter out those sub-sequences 18a, 18b in which a speech activity originates solely or predominantly from the user of the hearing device 2, because no spectral information about the preferred conversation partner 10 may reasonably be extracted in these sub-sequences 18a, 18b. In a second respect, the sub-sequences 18a, 18b are evaluated with regard to their signal quality. This may be done, for example, via the SNR 22 as well as via a speech intelligibility parameter 24 (which may be provided, for example, by the speech intelligibility index, SU). For a further analysis, only those sub-sequences 18a, 18b are used in which there is a sufficiently low or none of the hearing device 2 user's own speech activity, and which have a sufficiently high SNR 22 and sufficiently high SII 24.

Those of the shorter sub-sequences 18a that accordingly do not have any speech activity of the user of the hearing device 2 and also have a sufficiently high signal quality in the sense of SNR 22 and SII 24, are now analyzed with respect to pitch, frequencies of formats and spectra of individual sounds (“phones”) in order to ascertain speaker identification parameters 30 that are characteristic for the preferred conversation partner 10. In this case, the sub-sequences 18a are examined in particular for recurring patterns, for example formats that are specifically recognizable at one frequency or repeated, characteristic frequency progressions of the phones. In general—i.e. in particular also in other possible embodiments—an examination of whether the data from the first audio sequence 14 available for a certain preferred conversation partner 10 may be classified as “characteristic” may also be ascertained by comparison with the stored characteristic speaker identification parameters of other speakers, for example via a deviation of a particular frequency value or phone duration from an average of the corresponding stored values.

The longer sub-sequences 18b that are free of appreciable speech activity by the user of the hearing device 2 and have sufficiently high signal quality (see above) are analyzed with respect to the temporal distribution of stresses and speech pauses in order to ascertain additional speaker identification parameters 30 that are characteristic of the preferred conversation partner 10. Here too, the analysis may be carried out by way of recurring patterns and, in particular, by comparison with characteristic speaker identification parameters stored for other speakers and the corresponding deviations from these. The speaker identification parameters 30 ascertained from the sub-sequences 18a, 18b of the first audio sequence 14 are stored in a database 31 of the hearing device 2.

If a second image capture 32 is generated in the auxiliary device 4, this may likewise be examined in the above-described manner, analogously to the first image capture 8, for the presence of a preferred conversation partner, and in particular for the presence of the preferred conversation partner 10, and, if the latter is recognized, a second audio sequence 34 may be generated from the audio signal 12, analogously to the case described above. Characteristic speaker identification parameters 36 are also ascertained from the second audio sequence 34; for this purpose, the second audio sequence 34 is broken down into individual sub-sequences of two different lengths, in a manner not otherwise illustrated, but analogously to the first audio sequence 14; of these sub-sequences, in turn, only those with sufficiently high signal quality and without the hearing device user's own speech contributions are used for signal analysis with respect to the speaker identification parameters 36.

The speaker identification parameters 36 ascertained from the second audio sequence 34 may now be used to adjust the speaker identification parameters 30 ascertained from the first audio sequence 14 and already stored in the database 31 of a hearing device 2, so that they are saved with changed values if necessary. This may be done by means of averaging, in particular weighted or recursive, or by an artificial neural network. If, however, the deviations of the speaker identification parameters 36 ascertained from the second audio sequence 34, relative the already stored speaker identification parameters 30 ascertained from the first audio sequence 14, are below a predetermined threshold, it is assumed that the stored speaker identification parameters 30 characterize the preferred conversation partner with sufficient certainty, and the recognition phase 1 may be terminated.

Alternatively to the method described above, parts of the recognition phase 1 may also be carried out in the auxiliary device 4, in particular by means of the dedicated application 15, as indicated above. In particular, the determination of the characteristic speaker identification parameters 30 may be performed entirely on an auxiliary device 4 designed as a mobile telephone 6, in which case only the speaker identification parameters 30 are transferred from the mobile telephone 6 to the hearing device 2, for storage on a database 31 implemented in a memory of the hearing device 2.

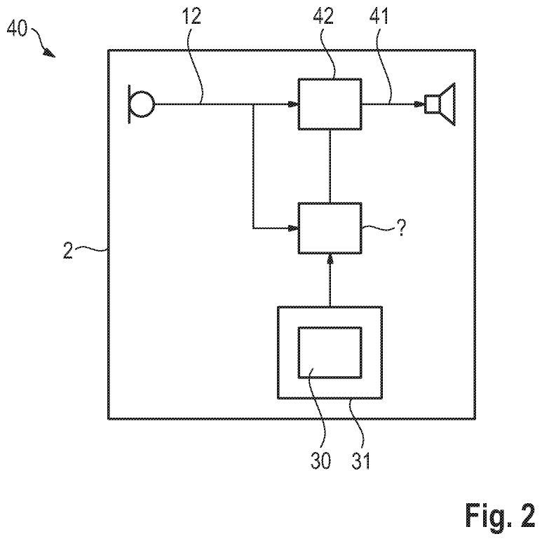

FIG. 2 is a schematic depiction of a block diagram of an application phase 40 of the method for individualized signal processing in the hearing device 2. The aim of the application phase 40 is to be able to recognize the speech contributions of the preferred conversation partner 10 in an input signal of the hearing device 2 based on the characteristic speaker identification parameters 30 that were ascertained and stored in the recognition phase 1, in order to be able to emphasize these contributions in a targeted manner against a noise background, but also against other speech contributions of other speakers, in an output signal 41 for the hearing device user 2.

When the recognition phase 1 is finished, the audio signal 12 of the hearing device 2 is analyzed in its operation with regard to the stored speaker identification parameters 30. If, based on a sufficiently high level of agreement between the signal components of the audio signal 12 and the stored speaker identification parameters 30 for the preferred conversation partner 10, certain signal components in the audio signal 12 are recognized as speech contributions of the preferred conversation partner 10, these speech contributions may be emphasized against a noise background and against other speakers' speech contributions. This may take place, for example, via a blind source separation (BSS) 42, or also via directional signal processing in the hearing device 2, using directional microphones. The BSS 42 is particularly advantageous in the case of a plurality of speakers, among which the preferred conversation partner 10 should be particularly emphasized, because no more detailed knowledge of that partner's position is required in order to carry out BSS, and knowledge of the partner's stored speaker identification parameters 30 may be used for BSS. The analysis of the audio signal 12 with regard to the presence of the preferred conversation partner 10, by means of the stored speaker identification parameters 30, may on the one hand automatically run in a background process; on the other hand, it may be started based on a certain hearing program—for example the program intended for a “cocktail party” hearing situation—either automatically through recognition of the hearing situation in the hearing device 2, or by the user of a hearing device 2 selecting the relevant hearing program.

In addition, the user of a hearing device 2 may initiate the analysis himself on an ad hoc basis by means of user input, if necessary via the auxiliary device 4, in particular via a dedicated application 15 for the method. In addition, the analysis of the audio signal 12 may also be triggered by a new image capture, in particular in a manner analogous to triggering the analysis in the recognition phase 1, i.e. by facial recognition taking place immediately when the image capture is generated and triggering the analysis in the event that the preferred conversation partner is recognized in a generated image capture.

Although the invention has been illustrated and described in greater detail with reference to the preferred exemplary embodiment, this exemplary embodiment does not limit the invention. Those of ordinary skill in the pertinent art will be able to derive other variations from this exemplary embodiment, without departing from the expressly protected scope of the invention.

The following is a list of reference numerals used in the above description of the invention with reference to the drawing figures:
1 Recognition phase
2 Hearing device
4 Auxiliary device
6 Mobile telephone
8 First image capture
10 Preferred conversation partner
12 Audio signal
14 First audio sequence
15 Dedicated (mobile) application
16 Trigger signal
18 Sub-sequence
18a, 18b Sub-sequence
20 OVD/(language recognition of own language)
22 SNR (signal-to-noise ratio)
24 SII/Speech intelligibility parameters
30 Speaker identification parameters
31 Database
32 Second image capture
34 Second audio sequence
36 Speaker identification parameters
40 Application phase
41 Output signal
42 BSS (blind source separation)

1. A method for individualized signal processing of an audio signal of a hearing device, the method comprising:
in a recognition phase:
generating a first image capture with an auxiliary device;
inferring a presence of a preferred conversation partner from the first image capture, and based thereon, analyzing a first audio sequence of the audio signal and/or an auxiliary audio signal of the auxiliary device for characteristic speaker identification parameters; and
storing the speaker identification parameters ascertained in the first audio sequence in a database; and
in an application phase:
analyzing the audio signal with respect to the stored speaker identification parameters, and thus evaluating the audio signal with respect to a presence of the preferred conversation partner; and
if the presence of the preferred conversation partner is detected, emphasizing the preferred conversation partner's signal contributions in the audio signal.

2. The method according to claim 1, which comprises recognizing the preferred conversation partner in the first image capture by way of facial recognition.

3. The method according to claim 1, which comprises using a mobile telephone and/or smartglasses as the auxiliary device.

4. The method according to claim 1, which comprises using the auxiliary device at least in part for analyzing and/or generating the audio signal in the recognition phase.

5. The method according to claim 1, which comprises analyzing at least one speaker identification parameter selected from the group consisting of:
a number of pitches;
a number of formant frequencies;
a number of phonospectra;
a distribution of stresses;
a chronological sequence of phones; and
a chronological sequence speech pauses

6. The method according to claim 1, which comprises:
decomposing the first audio sequence into a plurality of sub-sequences;
ascertaining for each of the respective sub-sequences a speech intelligibility parameter and/or a signal-to-noise ratio and comparing with an associated criterion; and
for the analysis with regard to the characteristic speaker identification parameters, using only those sub-sequences that fulfill the associated criterion.

7. The method according to claim 1, which comprises:
decomposing the first audio sequence into a plurality of sub-sequences;
monitoring in the hearing device a user's own speech activity; and
for the analysis with regard to the characteristic speaker identification parameters, using only those sub-sequences having a proportion of the user's own speech activity that does not exceed a predetermined upper limit.

8. The method according to claim 1, which comprises:
generating a second image capture with the auxiliary device and, in response to the second image capture, analyzing a second audio sequence of the audio signal and/or of an auxiliary audio signal of the auxiliary device with regard to characteristic speaker identification parameters; and
adapting the speaker identification parameters that are stored in the database by way of the speaker identification parameters ascertained from the second audio sequence.

9. The method according to claim 8, wherein the step of adapting the speaker identification parameters stored in the database using the speaker identification parameters that were ascertained from the second audio sequence comprises using averaging and/or an artificial neural network.

10. The method according to claim 8, which comprises terminating the recognition phase when a deviation of the speaker identification parameters that were ascertained from the second audio sequence, from among the speaker identification parameters stored in the database, falls below a threshold value.

11. The method according to claim 1, which comprises, in the application phase, initiating the step of analyzing the audio signal based on an additional image capture of the auxiliary device.

12. The method according to claim 1, which comprises:
in the first image capture, determining a number of persons present; and
analyzing the first audio sequence of the audio signal, or of the auxiliary audio signal of the auxiliary device, as a function of the number of persons present.

13. The method according to claim 1, which comprises:
generating the first image capture as part of a first image sequence;
in the first image sequence, detecting a speech activity of the preferred conversation partner; and
analyzing the first audio sequence of the audio signal, or of the auxiliary audio signal of the auxiliary device, as a function of the detected speech activity of the preferred conversation partner.

14. The method according to claim 1, wherein the step of emphasizing the signal contributions of the preferred conversation partner is based on directional signal processing and/or blind source separation.

15. A system, comprising:
a hearing device;
an auxiliary device configured to generate an image capture; and
said hearing device and said auxiliary device being commonly configured to perform the method according to claim 1.

16. The system according to claim 15, wherein said auxiliary device is a mobile telephone.

17. A mobile application for a mobile telephone, comprising non-transitory program code configured, when the mobile application is executed on the mobile telephone, for:
generating and/or detecting at least one image capture;
automatically recognizing a person in the at least one image capture who has been predefined as a preferred person; and
generating a start command for recording a first audio sequence of an audio signal and/or a start command for analyzing an audio sequence or the first audio sequence for characteristic speaker identification parameters in order to recognize the preferred person;
